(19) United States
(12) Patent Application Publication
(10) Pub. No.: US 2007/0009722 A1
(43) Pub. Date: Jan. 11, 2007

(54) Polymer/WUCS mat and method of forming same

(76) Inventor: Michael A. Strait, Johnstown, OH (US)

Correspondence Address: OWENS CORNING, 2790 COLUMBUS ROAD, GRANVILLE, OH, 43023, US

(21) Appl. No.: 11/178,989

(22) Filed: Jul. 11, 2005

(51) Int. Cl. B32B 27/04; B32B 27/32; B28B 3/00

(52) U.S. Cl. 428/220; 442/366; 428/297.4; 428/298.1; 264/642

(57) ABSTRACT

A chopped strand mat formed of bundles of dielectrically dried reinforcing fibers and bonding fibers is provided. The reinforcing fibers may be formed as bundles of wet reinforcing fibers with a bundle tex of about 10 to about 500. The reinforcing fibers may be formed of a single chop length of about 1 to about 1½ inches or a multi-chop length of fibers of about ½ to about 2 inches. The bonding materials may be any thermoplastic or thermosetting material having a melting point less than the reinforcing fiber. The chopped strand mat may be formed by dielectrically drying the wet reinforcement fibers, blending the reinforcement and bonding fibers, bonding the reinforcement and bonding fibers to form a chopped strand mat, compacting the mat, cooling the mat, and winding the mat into a continuous roll. The chopped strand mat contains a uniform or nearly uniform distribution of bonding fibers and bundles of dried reinforcement fibers.

### TECHNICAL FIELD AND INDUSTRIAL APPLICABILITY OF THE INVENTION

The present invention relates generally to reinforced composite products, and more particularly, to a chopped strand mat that is formed of bundles of dielectrically dried reinforcing fibers and bonding materials. A method of forming the chopped strand mat is also provided.

### BACKGROUND OF THE INVENTION

Glass fibers are useful in a variety of technologies. For example, glass fibers are commonly used as reinforcements in polymer matrices to form glass fiber reinforced plastics or composites. Glass fibers have been used in the form of continuous or chopped filaments, strands, rovings, woven fabrics, non-woven fabrics, meshes, and scrims to reinforce polymers. It is known in the art that glass fiber reinforced polymer composites possess higher mechanical properties compared to unreinforced polymers. Thus, better dimensional stability, tensile strength and modulus, flexural strength and modulus, impact resistance, and creep resistance can be achieved with glass fiber reinforced composites.

Typically, glass fibers are formed by drawing molten glass into filaments through a bushing or orifice plate and applying a sizing composition containing lubricants, coupling agents, and film-forming binder resins to the filaments. The aqueous sizing composition provides protection to the fibers from interfilament abrasion and promotes compatibility between the glass fibers and the matrix in which the glass fibers are to be used. After the sizing composition is applied, the fibers may be gathered into one or more strands and wound into a package or, alternatively, the fibers may be chopped while wet and collected. The collected chopped strands can then be dried and cured to form dry chopped fibers or they can be packaged in their wet condition as wet chopped fibers.

Fibrous mats, which are one form of fibrous non-woven reinforcements, are extremely suitable as reinforcements for many kinds of synthetic plastic composites. Dried chopped glass fiber strands (DUCS) are commonly used as reinforcement materials in thermoplastic articles. These dried chopped glass fibers may be easily fed into conventional machines and may be easily utilized in conventional methods, such as dry-laid processes. In a conventional dry-laid process, dried glass fibers are chopped and air blown onto a conveyor or screen and consolidated to form a mat. For example, dry chopped fibers and polymeric fibers are suspended in air, collected as a loose web on a screen or perforated drum, and then consolidated to form a randomly oriented mat.

Wet chopped fibers are conventionally used in a wet-laid process in which the wet chopped fibers are dispersed in a water slurry which may contain surfactants, viscosity modifiers, defoaming agents, or other chemical agents. Once the chopped glass fibers are introduced into the slurry, the slurry is agitated so that the fibers become dispersed. The slurry containing the fibers is deposited onto a moving screen, and a substantial portion of the water is removed to form a web. A binder is then applied, and the resulting mat is dried to remove the remaining water and cure the binder. The formed non-woven mat is an assembly of dispersed, individual glass filaments.

Dry-laid processes are particularly suitable for the production of highly porous mats and are suitable where an open structure is desired in the resulting mat to allow the rapid penetration of various liquids or resins. However, such conventional dry-laid processes tend to produce mats that do not have a uniform weight distribution throughout their surface areas, especially when compared to mats formed by conventional wet-laid processes. In addition, the use of dry chopped fibers can be more expensive to process than the wet chopped fibers used in wet-laid processes because the dry chopped fibers are generally dried and packaged in separate steps before being chopped.

For certain reinforcement applications in the formation of composite parts, it is desirable to form fiber mats in which the mat includes an open, porous structure (as in a dry-laid process) and which has a uniform weight (as in a wet-laid process). However, conventional wet chopped fibers cannot be employed in conventional dry-laid processes. For example, wet chopped fibers tend to agglomerate or stick to each other and/or the processing equipment, which would cause the manufacturing equipment to fail and stop the manufacturing line. In addition, conventional dry-laid processes typically employ an air stream to deliver the dry chopped strands to a moving screen or foraminous conveyor. Wet chopped fibers cannot be dispersed in such an air stream with sufficient control to obtain a mat that has a good dispersion of fibers.

Attempts have been made to dry the glass fiber strands as they are being collected at the winder or during an in-line process to improve the uniformity of the handling and subsequent processing of the glass fibers. Such drying attempts have included the use of high frequency dielectric systems for drying the glass strand and/or chopped glass fibers, some examples of which are set forth below.

U.S. Pat. No. 3,619,252 to Roscher discloses a method of coating and impregnating glass fibers with an aqueous elastomeric composition and then drying the glass fibers with high frequency electrical heating to remove substantially all of the water while leaving the elastomeric solids substantially unaffected.

U.S. Pat. No. 3,619,538 to Kallenborn discloses a process and an apparatus for employing high frequency electrical heating, such as dielectric heating, to dry a plurality of coated glass fibrous strands that are wet or saturated with an aqueous elastomeric dip.

U.S. Pat. No. 4,840,755, to Nakazawa et al. describes a method and an apparatus for producing compacted chopped strands having a high density. The chopped strands are dried by heated air applied from the lower side of the chopped strands or by high frequency wave heating as they are moved along a carrier plate.

U.S. Pat. No. 6,148,641 to Blough et al. describes an apparatus and a method for producing dried, chopped strands from a supply of continuous fiber strands by the direct deposition of wet, chopped strands ejected from a chopping assembly into a drying chamber. The drying chamber can be any continuous or batch type dryer known to one skilled in the art such as electric, gas, ultraviolet, dielectric, or fluidized bed dryers.

In view of the above, there exists a need in the art for a cost-effective and efficient process for forming a non-woven mat having a substantially uniform weight distribution, and an open, porous structure that can be used in the production of reinforced composite parts and that utilizes wet chopped strands.

### SUMMARY OF THE INVENTION

It is an object of the present invention to provide a low-loft, non-woven chopped strand mat that is formed of bundles of reinforcing fibers and a bonding material. Suitable examples of reinforcing fibers include glass fibers, wool glass fibers, natural fibers, and ceramic fibers. The reinforcing fibers may be present in the chopped strand mat in an amount of about 60 to about 90% by weight of the total fibers. It is preferred that the bundles of reinforcing fibers have a bundle tex of about 10 to about 500. In preferred embodiments, the reinforcing fibers are wet reinforcing fibers, such as wet use chopped strand glass fibers, that have been substantially dried using a dielectric drying oven. The bonding material may be any thermoplastic or thermosetting material having a melting point less than the reinforcing fibers.

It is also an object of the present invention to provide a method of forming a low-loft, non-woven chopped strand mat. In forming the chopped strand mat, bundles of wet reinforcement fibers (such as wet use chopped strand glass fibers) are dielectrically dried such as by passing the wet reinforcement fibers through a dielectric oven where high alternating frequency electrical fields dry or substantially dry the wet reinforcement fibers. The dried bundles of reinforcement fibers are fed by a first fiber transfer system into a forming hood. A second fiber transfer system feeds a thermoplastic bonding material into the forming hood. The fiber transfer systems may be slaved to each other so that a matched ratio of bonding material to reinforcing fiber can be obtained. The dried reinforcement fibers and bonding material are blended together in the forming hood by a high velocity air stream. The mixture of dried reinforcement fibers and bonding material are pulled downward within the forming hood and onto a moving conveying apparatus with the aid of a vacuum or air suction system to form a sheet of randomly, but substantially evenly distributed, bundles of dried reinforcement fibers and bonding fibers. The sheet is then passed through a thermal bonding system to bond the dried reinforcement fibers and bonding material and form the chopped strand mat. The chopped strand mat may be passed through a compacting system where the chopped strand mat is compacted, preferably to a thickness of from about 1/16 to about ½ inch. The chopped strand mat may be further processed by passing the chopped strand mat through a cooling system and then wound by a winding apparatus into a continuous roll for storage.

It is a further object of the present invention to provide a method of forming a low-loft, non-woven chopped strand that utilizes a polymer mat as the binding material. Wet reinforcement fibers that have been dielectrically dried, such as in a dielectric oven, are deposited into a forming hood by a first fiber transfer system. Preferably, the wet reinforcement fibers are formed as bundles of reinforcing fibers with a bundle tex of from about 10 to about 500. The dried reinforcement fibers are suspended by a high velocity air stream generated within the forming hood. A first polymer mat is positioned onto a conveying apparatus and introduced into the forming hood. The dried reinforcement fibers are drawn downward and deposited onto the first polymer mat. The result is a polymer mat having thereon a substantially even distribution of dried bundles of wet reinforcement fibers. The polymer/glass mat may then be passed through a thermal bonding system to bond at least a portion of the dried reinforcement fibers and the polymer material forming the first polymer mat. A second polymer mat may optionally be positioned on the layer of dried bundles of reinforcement fibers such that the dried bundles of reinforcement fibers are sandwiched between the first and second polymer mats. The first and second polymer mats may be formed of the same polymers or they may be formed of different polymers, depending on the desired application.

It is an advantage of the present invention that the use of dielectrically dried wet chopped glass fibers provides a cost advantage over conventional low tex roved fiber products which are currently used in dry-laid processes. As a result, the use of dielectrically dried wet chopped glass fibers allows chopped strand mats to be manufactured at lower costs.

It is another advantage of the present invention that dielectrically drying the wet reinforcement fibers provides an economic method of removing water from the wet reinforcement fibers because the wet reinforcement fibers may be quickly dried at a low net fiber temperature. In addition, dielectrically drying the wet reinforcement fibers enhances fiber-to-fiber cohesion and reduces bundle to bundle adhesion.

It is a further advantage of the present invention that in removing the water from the wet reinforcement fibers at lower temperatures through dielectric drying, the chemical reactions of the surface chemistry on the glass fibers may be reduced.

It is yet another advantage of the present invention that the use of a dielectric oven permits the wet reinforcing fibers to be dried with no active method of fiber agitation. This lack of agitation eliminates the abrasion of fibers commonly seen in conventional fluidized bed and tray drying ovens due to the high air flow velocities within the drying ovens and the mechanical motion of the fibrous material in the beds. In addition, the lack of agitation greatly increases the ability to maintain the fiber bundles.

It is also an advantage of the present invention that the dielectric oven reduces the discoloration of glass commonly resulting from the use of thermal drying process equipment.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a chopped strand bundle according to an exemplary embodiment of the present invention;

FIG. 2 is a flow diagram illustrating steps for forming a chopped strand mat using wet reinforcement fibers according to one aspect of the present invention;

FIG. 3 is a schematic illustration of a process using dielectrically dried reinforcement fibers to form a chopped strand mat according to at least one exemplary embodiment of the present invention; and

FIG. 4 is a schematic illustration of a forming hood according to at least one exemplary embodiment of the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. The terms “top”, “bottom”, “side”, and the like are used herein for the purpose of explanation only. It will be understood that when an element is referred to as being “on,” “adjacent to,” or “against” another element, it can be directly on, adjacent to, or against the other element or intervening elements may be present. It will also be understood that when an element is referred to as being “over” another element, it can be directly over the other element, or intervening elements may be present. The terms “reinforcing fibers” and “reinforcement fibers” may be used interchangeably herein. The terms “bonding fibers” and “bonding material” may also be interchangeably used. In addition, the terms “sheet” and “mat” may be used interchangeably herein.

The present invention relates to a chopped strand mat that is formed of bundles of reinforcing fibers and organic bonding fibers. The chopped strand mat is a low loft, non-woven mat that may be used, for example, as a reinforcement in composite articles, in injection molding, in pultrusion processes, in structural resin injection molding, in open mold resin systems, in closed mold resin systems, in polymer gypsum reinforcement, in polymer concrete reinforcement, in compression molding, in resin transfer molding, and in vacuum infusion processes.

The reinforcing fibers may be any type of organic, inorganic, or natural fiber suitable for providing good structural qualities. Preferred examples of suitable reinforcing fibers include glass fibers, wool glass fibers, natural fibers, and ceramic fibers. The chopped strand mat may be entirely formed of one type of reinforcement fiber (such glass fibers) or, alternatively, more than one type of reinforcement fiber may be used in forming the chopped strand mat. The term “natural fiber” as used in conjunction with the present invention refers to plant fibers extracted from any part of a plant, including, but not limited to, the stem, seeds, leaves, roots, or bast. Preferably, the reinforcing fibers are glass fibers.

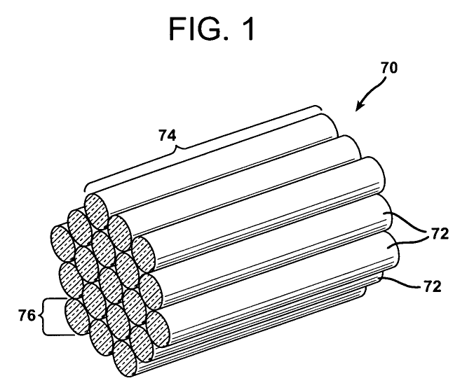

The reinforcing fibers may be chopped fibers having a discrete length of about ½ to about 2 inches, and preferably about ¾ to about 1½ inches. In addition, the reinforcing fibers may be formed of a single chop length of about 1 to about 1½ inches or a multi-chop length of fibers ranging from about ½ to about 2 inches. The reinforcing fibers may have diameters of about 10 to about 22 microns, preferably from about 12 to about 16 microns, and more preferably from about 11 to about 12 microns. It is preferred that the reinforcing fibers are formed as bundles of reinforcing fibers with a bundle tex of from about 10 to about 500, preferably from about 20 to about 400, and more preferably from about 30 to about 100. An example of a suitable chopped strand bundle is illustrated in FIG. 1. The chopped strand bundle 70 shown therein is formed of individual filaments 72 having a discrete desired length 74 and desired diameter 76 as described above.

Although not wishing to be bound by theory, it is believed that when the tex of each bundle reaches a sufficient amount, the fibers form an assembly of fibrous “sticks” that are held together by the bonding material. A chopped strand mat formed from these high tex bundles of reinforcing fibers will result in a low-loft chopped strand mat that wets out in a resin quickly and that will be relatively thin, especially when compared to conventional high-loft air-laid mat products. In addition, the low-loft bundled chopped glass fiber mats are formed of fibers packed together along the fiber axis, which permits the chopped glass mat to have an increased glass content. In composite mats such as the chopped strand mat of the present invention, mechanical and impact performance are directly proportional to the glass content. Because the chopped strand mat has an increased glass content, it is able to provide increased mechanical and impact performance in the final products, especially when compared to the conventional high-loft dry-laid mat products that have dispersed fibers and a limited glass content (e.g., about 20 to about 30% glass).

The reinforcing fibers may have varying lengths and diameters from each other within the chopped strand mat, and may be present in an amount of from about 60 to about 90% by weight of the total fibers. Preferably, the reinforcing fibers are present in the chopped strand mat in an amount of about 80 to about 90% by weight. In a most preferred embodiment, the reinforcing fibers are present in an amount of about 90% by weight.

The bonding material may be any thermoplastic or thermosetting material that has a melting point less than the melting point of the reinforcing fibers. Non-limiting examples of thermoplastic and thermosetting materials suitable for use in the chopped strand mat include polyester fibers, polyethylene fibers, polypropylene fibers, polyethylene terephthalate (PET) fibers, polyphenylene sulfide (PPS) fibers, polyvinyl chloride (PVC) fibers, ethylene vinyl acetate/vinyl chloride (EVA/VC) fibers, lower alkyl acrylate polymer fibers, acrylonitrile polymer fibers, partially hydrolyzed polyvinyl acetate fibers, polyvinyl alcohol fibers, polyvinyl pyrrolidone fibers, styrene acrylate fibers, polyolefins, polyamides, polysulfides, polycarbonates, rayon, nylon, phenolic resins, and epoxy resins. The bonding material may be present in the chopped strand mat in an amount of from about 10 to about 40% by weight of the total fibers, and preferably from about 10 to about 20% by weight. In a most preferred embodiment, the bonding material is present in the chopped strand mat in the in an amount of about 10% by weight.

In addition, the bonding fibers may be functionalized with acidic groups, for example, by carboxylating with an acid such as a maleated acid or an acrylic acid, or the bonding fibers may be functionalized by adding an anhydride group or vinyl acetate. The bonding material may also be in the form of a flake, a granule, a resin, or a powder rather than in the form of a polymeric fiber.

The bonding material may also be in the form of multicomponent fibers such as bicomponent polymer fibers, tricomponent polymer fibers, or plastic-coated mineral fibers such as thermosetting coated glass fibers. The bicomponent fibers may be arranged in a sheath-core, side-by-side, islands-in-the-sea, or segmented-pie arrangement. Preferably, the bicomponent fibers are formed in a sheath-core arrangement in which the sheath is formed of first polymer fibers that substantially surround a core formed of second polymer fibers. It is not required that the sheath fibers totally surround the core fibers. The first polymer fibers have a melting point lower than the melting point of the second polymer fibers so that upon heating the bicomponent fibers to a temperature above the melting point of the first polymer fibers (sheath fibers) and below the melting point of the second polymer fibers (core fibers), the first polymer fibers will soften or melt while the second polymer fibers remain intact. This softening of the first polymer fibers (sheath fibers) will cause the first polymer fibers to become sticky and bond the first polymer fibers to themselves and other fibers that may be in close proximity.

The chopped strand mat may be formed by a dry-laid process, such as any of the conventional dry-laid processes known to those of skill in the art. In preferred embodiments, the reinforcing fibers used to form the chopped strand mat are wet reinforcing fibers that have been substantially dried using a dielectric drying oven. As used herein, the phrase “substantially dried” is meant to indicate that the wet reinforcing fibers are dry or nearly dry. In preferred embodiments, the wet reinforcement fibers are wet use chopped strand glass fibers (WUCS). Wet use chopped strand glass fibers for use as the reinforcement fibers may be formed by conventional processes known in the art. It is desirable that the wet use chopped strand glass fibers have a moisture content of from 5-30%. It is even more preferred that the wet use chopped strand glass fibers have a moisture content of from about 5 to about 15%. 100391 The use of dielectrically dried wet use chopped strand glass fibers provides a cost advantage over conventional low tex roved fiber products (such as rovings) which are currently used in dry-laid processes. For example, wet use chopped strand glass fibers are less expensive to manufacture than roved fibers because roved fibers require multiple manufacturing steps such as winding, drying, creel loading, unwinding, and chopping to obtain a fiber that can be used in manufacturing processes. The use of dielectrically dried wet use chopped strand glass fibers allows chopped strand mats to be manufactured at lower costs. In addition, as a roving is dried, the size on the glass fibers tends to migrate toward the outside of the package, which causes an uneven distribution of size throughout the roving package. The outside of the roving package is typically removed and discarded as waste. The inventive chopped strand mat does not result in a migration of size and, as a result, reduces the amount of waste generated.

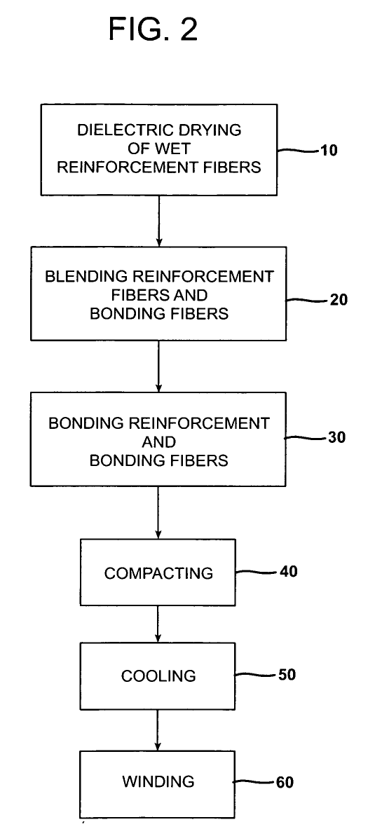

An exemplary process for forming the chopped strand mat using dielectrically dried reinforcement fibers is generally illustrated in FIG. 2. The process shown therein includes dielectrically drying the wet reinforcement fibers (10), blending the dried reinforcement fibers and bonding material (20), bonding the reinforcement fibers and bonding material (30), compacting the chopped strand mat (40), cooling the chopped strand mat (50), and winding the mat into a continuous roll (60).

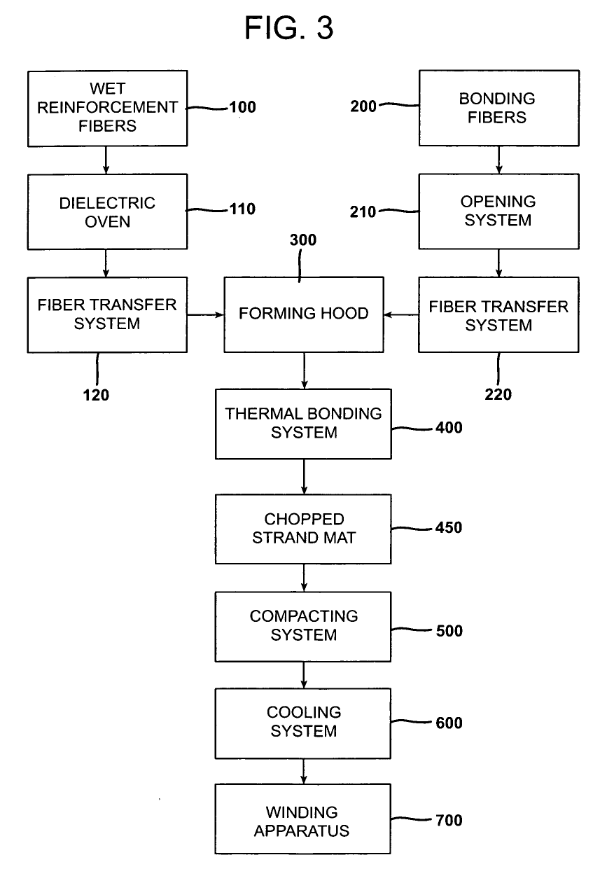

The formation and storage of a chopped strand mat according to an exemplary embodiment of the instant invention is depicted in FIG. 3. As illustrated in FIG. 3, wet reinforcement fibers 100 are introduced into a dielectric oven 110. Preferably, these wet reinforcement fibers are present in bundles. The dielectric oven 1 10 includes spaced electrodes that produce alternating high-frequency electrical fields between successive oppositely charged electrodes. The wet reinforcement fibers pass between the electrodes and through the electrical fields where the high alternating frequency electrical fields act to excite the water molecules and raise their molecular energy to a level sufficient to cause the water within the reinforcement fibers to evaporate.

The amount of electrical activation and duration of time within the dielectric oven 110 are controlled such that the reinforcement fibers that leave the dielectric oven 110 are substantially dry and non-tacky. The duration of drying time may be controlled through a closed loop feed back of the power draw that the dielectric oven 110 is experiencing to determine when the reinforcing fibers are substantially dry. In exemplary embodiments, greater than about 70% of the free water (water that is external to the reinforcement fibers) is removed. Preferably, however, substantially all of the water is removed by the dielectric oven 110. It should be noted that the phrase “substantially all of the water” as it is used herein is meant to denote that all or nearly all of the free water is removed.

The dielectric oven 110 permits the wet reinforcing fibers 100 to be quickly dried at a low net fiber temperature. The net fiber temperature is dependent upon the chemistry of the size coating the glass fiber, which, in turn, is dependent upon the intended application. Therefore, the dielectric oven 110 provides an economic method of removing water from the wet reinforcement fibers 100. In addition, dielectrically drying the bundles of wet reinforcement fibers enhances fiber-to-fiber cohesion and reduces bundle-to-bundle adhesion. The dielectric energy penetrates the wet bundles of chopped fibers evenly and causes the water to quickly evaporate, helping to keep the wet glass bundles separated from each other. Further, the dielectric drying of the size on the chopped fibers also assists in filimentizing the bundles in the chopped strand mat during subsequent processing steps (such as molding the chopped strand mat) to form an aesthetically pleasing finished product. The dielectric drying lightly cures the size so that even filimentation can occur.

By removing the water from the wet reinforcement fibers at lower temperatures, the chemical reactions of the surface chemistry (e.g., size) may be reduced. Sizing compositions may contain a variety of components, depending on the application of the fibers. As one example, an epoxy film forming agent may be utilized in the size applied to the glass fibers in order to provide compatibility with epoxy resin systems. In conventional dry-laid processes, all or nearly all of the epoxy functional groups within the film forming agents in the size composition are reacted due to the extended drying time and high temperatures typical of conventional thermal drying processes. However, by dielectrically drying the size on the glass fibers at a lower temperature and for a shorter time period, active epoxy functional groups remain imbedded in the size on the glass. Further, the lower temperature of the dielectric oven and shorter drying time needed to dry the size reduces the discoloration of glass that commonly results from the use of thermal drying process equipment.

The dielectric oven 110 permits the wet reinforcing fibers 100 to be dried with no active method of fiber agitation as is conventionally required to remove moisture from wet fibers. This lack of agitation reduces or eliminates the attrition or abrasion of fibers as is commonly seen in conventional fluidized bed and tray drying ovens due to the high air flow velocities within the ovens and the mechanical motion of the fibrous material in the beds. In addition, the lack of agitation greatly increases the ability of the dielectric oven 110 to maintain the fibers in bundles and not filamentize the fiber strands as in the aggressive conventional thermal processes.

Once the dried reinforcement fibers (such as dried WUCS fibers) leave the dielectric oven 110, they are fed by a first fiber transfer system 120 into a forming hood 300. As used herein, the term “dried reinforcement fibers” is meant to denote reinforcement fibers that have all of the free water removed or nearly all of the free water removed. The first fiber transfer system 120 may be any kind of loss-in-weight or continuous weigh feeding or dispensing device that feeds the dried fibers (not shown) into the forming hood 300 at a controlled rate.

The bonding material 200, typically present in the form of a bale of fibers, is fed into an opening system 210 to at least partially open and/or filamentize (individualize) the bonding fibers 200. The opening system 210 is preferably a bale opener, but may be any type of opener suitable for opening the bales of bonding fibers 200. The design of the openers depends on the type and physical characteristics of the fiber being opened. Suitable openers for use in the present invention include any conventional standard type bale openers with or without a weighing device. The weighing device serves to continuously weigh the partially opened fibers as they are passed through the bale opener to monitor the amount of fibers that are passed onto the next processing step. The bonding fibers 200 exiting the opening system 210 are then fed into a second fiber transfer system 220 that feeds the bonding fibers 200 to the forming hood 300. The fiber transfer system 120 may be slaved to the fiber transfer system 220 to provide a matched ratio of bonding material to reinforcing fiber.

In alternate embodiments where the bonding fibers are in the form of a flake, granule, or powder, the opening system 210 and second fiber transfer system 220 may be replaced with an apparatus suitable for distributing the flakes, powders, or granules to the forming hood 300 so that these resinous materials may be mixed with the dried reinforcement fibers (not shown) in the forming hood 300. A suitable distribution apparatus would be easily identified by those of skill in the art.

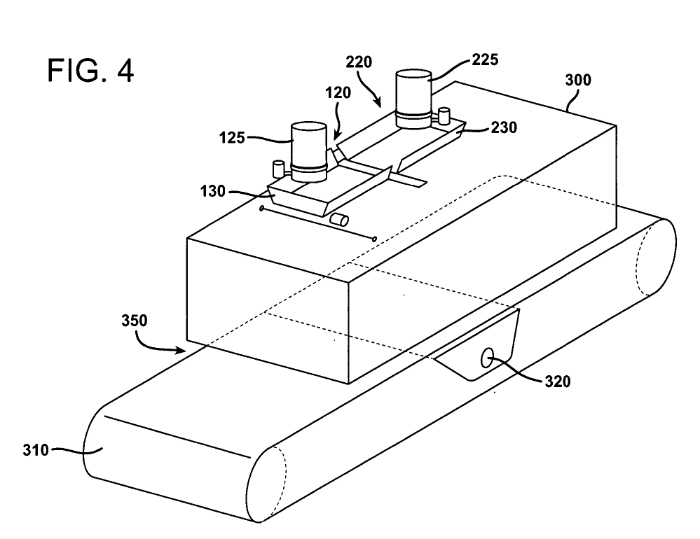

The bundles of dried reinforcement fibers and the bonding fibers 200 are blended together within the forming hood 300. An exemplary embodiment of a forming hood 300 is illustrated in FIG. 4. In preferred embodiments, the fibers are blended in a high velocity air stream generated within the forming hood 300 such as by a fan (e.g., a burster fan). It is desirable to distribute the bundles of dried reinforcing fibers and bonding fibers 200 as uniformly as possible within the air stream. The ratio of dried reinforcing fibers and bonding fibers 200 entering the forming hood 300 may be controlled by the weight feed rate at which the fibers are passed through the first and second fiber transfer systems 120, 220. For example, the control of fibers through the first and second fiber transfer systems 120, 220 may be achieved through loss-in-weight vibratory feeders such as a vibrator pan or weigh belt. In the exemplary embodiment depicted in FIG. 4, the fiber transfer systems 120, 220 are combinations of a dispensing unit 125, 225 and a vibratory feeder 130, 230 respectively. The ratio of dried reinforcing fibers to bonding fibers 200 present in the air stream is preferably 90:10 to 60:40, dried reinforcement fibers to bonding material 200 respectively.

The mixture of the dried reinforcement fibers and bonding fibers 200 are pulled downward within the forming hood 300 and onto a moving conveying apparatus 310 with the aid of a vacuum or air suction system 320 to form a sheet of randomly, but substantially evenly distributed, bundles of dried reinforcement fibers and bonding material 200. The conveying apparatus 310 may be any suitable conveyor identified by one of skill in the art (e.g., a foraminous conveyor). The sheet may then be passed through a thermal bonding system 400 to bond the dried bundles of reinforcement fibers and bonding fibers 200. In thermal bonding, the thermoplastic properties of the bonding fibers 200 are used to form bonds with the dried reinforcement fibers upon heating. The sheet contains a substantially uniform distribution of dried reinforcing fibers and bonding fibers 210 at a desired ratio and weight distribution. The uniform or substantially uniform distribution of fibers provides improved strength as well as improved acoustical and thermal properties to the chopped strand mat 450. As used herein, the phrases “substantially uniform distribution of fibers” and “substantially evenly distributed fibers” are meant to denote that the fibers are uniformly or evenly distributed or nearly uniformly or evenly distributed.

In the thermal bonding system 400, the sheet is heated to a temperature that is above the melting point of the bonding material 200 but below the melting point of the dried reinforcement fibers. When bicomponent fibers are used as the reinforcement fibers 200, the temperature in the thermal bonding system 400 is raised to a temperature that is above the melting point of the sheath fibers, but below the melting point of the reinforcement fibers. Heating the bonding fibers 200 to a temperature above their melting point, or above the melting point of the sheath fibers in the instance where the bonding fibers 200 are bicomponent fibers, causes the bonding fibers 200 (or sheath fibers) to become adhesive and bond the bonding fibers 200 and dried bundles of reinforcing fibers. If the bonding fibers 200 completely melt, the melted fibers may encapsulate dried bundles of reinforcement fibers. As long as the temperature within the thermal bonding system 400 is not raised as high as the melting point of the reinforcing fibers and/or core fibers, these fibers will remain in a fibrous form within the thermal bonding system 400 and chopped strand mat 450.

The thermal bonding system 400 may include any known heating and bonding method known in the art, such as oven bonding, infrared heating, hot calendaring, belt calendaring, ultrasonic bonding, microwave heating, and heated drums. Optionally, two or more of these bonding methods may be used in combination to bond the fibers in the sheet. The temperature of the thermal bonding system 400 varies depending on the melting point of the bonding fibers 200 used and whether or not bicomponent fibers are present in the sheet. However, the temperature within the thermal bonding system may be about 200 to about 350° C. The chopped strand mat 450 that emerges from the thermal bonding system 400 contains a uniform or nearly uniform distribution of bonding fibers 200 and bundles of dried reinforcement fibers.

The chopped strand mat 450 may be passed through a compacting system 500 where the mat is compacted, preferably to a thickness of about 1/16 to about ½ inch. The compacting system may be a series of rollers or a single compaction roll set. The compaction rolls may include a set of chrome coated rolls including a gap control system with chilled water circulating through the rolls to keep the surface at a temperature ranging from about 50 to about 70° F.

The chopped strand mat 450 may also be passed through a cooling system 600. The cooling system may include a conveyor and a drive, such as a motor, to move the conveyor. A blower apparatus (not illustrated) may be located below the conveyor to generate suction and pull air through the chopped strand mat 450, e.g., from the top to the bottom. The air is preferably drawn in at the ambient temperature and is used to drive the temperature of the chopped strand mat 450 to room temperature. Alternatively, the air may be drawn through a cooling coil (not illustrated) to lower the temperature of the air and increase the cooling effect on the chopped strand mat 450. The chopped strand mat 450 may then be wound by a winding apparatus 700 onto a continuous roll (not shown) for storage for later use. Any conventional winding apparatus is suitable for use in the instant invention. The chopped strand mat 450, as well as the glass polymer mat described below, may be utilized in a number of non-structural acoustical applications such as in appliances, in office screens and partitions, in ceiling tiles, in building panels, and in semi-structural applications such as, for example, headliners, hood liners, floor liners, trim panels, parcel shelves, sunshades, instrument panel structures, door inners, or wall panels or roof panels of recreational vehicles.

In an alternate embodiment (not illustrated), wet reinforcement fibers that have been dielectrically dried as described above are deposited into the forming hood 300, such as by the first fiber transfer system 120, and suspended by the high velocity air stream generated within the forming hood 300. Preferably, the wet reinforcement fibers are formed as bundles with a bundle tex of 10 to 500. The bundles of wet reinforcement fibers 200 may be passed through a dielectric oven 110 or other apparatus that generates electrical fields and dries the wet fibers. The dried bundles of wet reinforcement fibers may then be transferred to the forming hood 300. A first polymer mat (not illustrated) may be placed onto the conveying apparatus 310 and introduced into the forming hood 300 at entrance 350 (depicted in FIG. 4). The first polymer mat may be a mat of randomly oriented polymer fibers. Suitable polymer fibers include, but are not limited to, polyester fibers, polyethylene fibers, polypropylene fibers, polyethylene terephthalate (PET) fibers, polyphenylene sulfide (PPS) fibers, polyvinyl chloride (PVC) fibers, ethylene vinyl acetate/vinyl chloride (EVA/VC) fibers, lower alkyl acrylate polymer fibers, acrylonitrile polymer fibers, partially hydrolyzed polyvinyl acetate fibers, polyvinyl alcohol fibers, polyvinyl pyrrolidone fibers, styrene acrylate fibers, polyolefins, polyamides, polysulfides, polycarbonates, rayon, nylon, phenolic resins, and epoxy resins.

The dried bundles of wet reinforcement fibers are drawn downward and deposited onto the first polymer mat with the aid of a vacuum or other type of suction apparatus. The result is a polymer mat having thereon a substantially even distribution of dried bundles of wet reinforcement fibers. The polymer/glass mat may then be passed through the thermal bonding system 400 to bond the dried bundles of reinforcement fibers and the polymer material forming the first polymer mat. The temperature within the thermal bonding system 400 is variable and depends upon the polymer component(s) forming the polymer mat. The temperature is a temperature that is high enough to at least partially melt the polymer material(s) in the polymer mat and bond the dried wet reinforcement fibers and polymer material to form a polymer/glass mat. The polymer/glass mat may then be compacted, cooled, and rolled as described above.

A second polymer mat (not shown) may be positioned on the layer of dried bundles of wet reinforcement fibers such that the dried bundles of reinforcement fibers are sandwiched between the first and second polymer mats. The first and second polymer mats may be formed of the same polymers or they may be formed of different polymers, depending on the desired application. The second polymer mat may be affixed to the reinforcing fibers by thermal bonding as described above.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

### Bundle Integrity

A sizing composition according to Table 1 was mixed and applied with a cylindrical applicator roll to 13 μm fibers at a glass bushing throughput of 70 pounds per hour with a tip plate of 2052 tips.

TABLE 1

| | % | Input | | | As |
|---|---|---|---|---|---|
| Material | Solids | Fraction | Fraction | g/100 g | Received |
| PD-166^{(a)} | 54.5 | 0.53 | 0.585 | 280.79 | 515.22 |
| Acetic Acid | 100 | 0.006 | 0.007 | 3.18 | 3.18 |
| A-1100^{(b)} | 58.0 | 0.015 | 0.016 | 7.95 | 13.7 |
| PVP K-90^{(c)} | 22.0 | 0.33 | 0.364 | 174.83 | 794.7 |
| Emery | 50.0 | 0.025 | 0.028 | 13.25 | 26.49 |
| 6760L^{(d)} | | | | | |
| D.M. Water | 0 | | | | 14646.71 |
| Total | | 0.906 | 1.0 | 480.0 | 16000.00 |

^{(a)}PD-166 is a polyvinyl acetate emulsion from HB Fuller.
^{(b)}A-1100 is an aminosilane available from General Electric Silicones Division.
^{(c)}PVP K-90 is a polyvinylpyrrolidone solution from International Specialty Products.
^{(d)}Emery 6760 L is a polyethylenimine-fatty acid lubricant from Cognis.

The glass strand was divided into 16 sections to give a strand tex of approximately 40 tex. The strand was chopped with a CB 73 chopper into ¼ inch lengths and deposited into a plastic tub. The chopped strands were then dried in a PSC stray field RF (dielectric) oven from a moisture content of approximately 15% to an approximate 0% moisture content at about 30 lb/hr. The resulting mass of bundles was easily divided (broken) into individual bundles of fibers. The moisture content was determined to be less than 0.5% by weight. The individual bundles were characterized as displaying excellent bundle stiffness.

Approximately 300 g of the bundles were then transferred by hand into a “Preformer” (an enclosed box with a large downdraft of air used to make glass mats called preforms). This amount was sufficient to give an areal density of about 1 ounce per square foot. E-240-8 mat binder (a ground-powdered thermosetting polyester binder with benzoyl peroxide catalyst available from AOC) was sprinkled by hand onto the mat. The mat was transferred into a 450° F. forced air oven for 10 minutes. The mat was removed and cooled. The mat was determined to display excellent bundle integrity and strength.

### Example 2

### Dielectric Drying and Air Laid Mats

A sizing composition according to Table 2 was mixed and applied with a cylindrical applicator roll to 16 μm fibers at a glass bushing throughput of 70 pounds per hour with a tip plate of 2052 tips.

TABLE 2

| | % | Input | | | As |
|---|---|---|---|---|---|
| Material | Solids | Fraction | Fraction | g/100 g | Received |
| HP3-02^{(a)} | 32.0 | 0.75 | 0.939 | 302.44 | 945.13 |
| Acetic Acid | 100.0 | 0.006 | 0.008 | 2.420 | 2.42 |
| A-1100^{(b)} | 58.0 | 0.0375 | 0.047 | 15.12 | 26.07 |
| K-12^{(c)} | 100.0 | 0.005 | 0.006 | 2.02 | 2.02 |
| D.M. Water | 0 | | | 0.00 | 6024.36 |
| Total | | 0.7985 | 1.0 | 322 | 7000.00 |

^{(a)}HP3-02 is a polyurethane dispersion in water from Hydrosize, Inc.
^{(b)}A-1100 is an aminosilane available from General Electric Silicones Division.
^{(c)}K-12 is a polyethylenimine-fatty acid lubricant available from AOC.

The glass strand divided into 16 sections to give a strand tex of approximately 70 tex. The strands were chopped with a CB 73 chopper into 1¼ inch lengths. The chopped fibers were deposited into a plastic tub and dried in a PSC stray field RF (dielectric) oven from a moisture content of approximately 15% to an approximate 0% moisture content at about 30 lb/hr. The resulting bundle mass was easily broken into individual bundles. The moisture content was determined to be less than 0.5% by weight. The bundles were placed into plastic bags. The bags were then inverted to determine how well the fiber bundles dispersed from each other and how well the bundles flowed past each other. A visual inspection determined that the individual bundles flowed very easily and were well dispersed.

Approximately 300 g of the bundles were transferred by hand into a “Preformer” (an enclosed box with a large downdraft of air used to make glass mats called preforms). This amount was sufficient to give an areal density of about 1 ounce per square foot. E-240-8 mat binder (a ground-powdered thermosetting polyester binder with benzoyl peroxide catalyst available from AOC) was sprinkled by hand onto the mat. The mat was transferred into a 450° F. forced air oven for 10 minutes. The mat was removed and cooled. The chopped strand mat displayed excellent bundle integrity and strength.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A non-woven chopped strand mat comprising:
bundles of dielectrically dried wet reinforcement fibers; and
a thermoplastic bonding material having a melting point less than the melting point of said bundles of dielectrically dried wet reinforcement fibers, said thermoplastic bonding material bonding to at least a portion of said bundles of dielectrically dried wet reinforcement fibers, said bundles of dielectrically dried wet reinforcement fibers being substantially uniformly distributed throughout said chopped strand mat.

2. The chopped strand mat of claim 1, wherein said wet reinforcement fibers comprise at least one member selected from glass fibers, wool glass fibers, natural fibers and ceramic fibers.

3. The chopped strand mat of claim 2, wherein said chopped strand mat has a compacted thickness of about 1/16 to about ½ of an inch.

4. The chopped strand mat of claim 2, wherein said bundles of dielectrically dried wet reinforcement fibers have a bundle tex of from about 10 to about 500.

5. The chopped strand mat of claim 4, wherein said wet reinforcement fibers have a length of about ½ to about 2 inches.

6. The chopped strand mat of claim 2, wherein said thermoplastic bonding material is selected from polyester fibers, polyethylene fibers, polypropylene fibers, polyethylene terephthalate fibers, polyphenylene sulfide fibers, polyvinyl chloride fibers, ethylene vinyl acetate/vinyl chloride fibers, lower alkyl acrylate polymer fibers, acrylonitrile polymer fibers, partially hydrolyzed polyvinyl acetate fibers, polyvinyl alcohol fibers, polyvinyl pyrrolidone fibers, styrene acrylate fibers, polyolefins, polyamides, polysulfides, polycarbonates, rayon, nylon, phenolic resins and epoxy resins.

7. A method of forming a non-woven chopped strand mat comprising the steps of:
dielectrically drying bundles of wet reinforcement fibers to form dried bundles of reinforcement fibers;
blending said dried bundles of reinforcement fibers and a thermoplastic bonding material having a melting point lower than the melting point of said dried bundles of reinforcement fibers to form a mixture of said dried bundles of reinforcement fibers and said thermoplastic bonding material;
depositing said mixture onto a conveying apparatus to form a sheet, said sheet containing a substantially even distribution of said dried bundles of reinforcement fibers and said thermoplastic bonding material throughout said sheet; and
bonding said dried bundles of reinforcement fibers and said thermoplastic bonding material to form a chopped strand mat.

8. The method of claim 7, wherein said step of dielectrically drying said bundles of wet reinforcement fibers comprises:
introducing said bundles of wet reinforcement fibers into a dielectric oven wherein said bundles of wet reinforcement fibers are passed through high alternating frequency electrical fields and dried.

9. The method of claim 8, wherein said blending step comprises:
conveying said dried bundles of reinforcement fibers and said thermoplastic bonding material to a forming hood where said dried bundles of reinforcement fibers and said thermoplastic bonding material are dispersed in an air stream.

10. The method of claim 8, wherein in said depositing step, the mixture is deposited onto said conveying apparatus by a vacuum positioned on a side of said conveying apparatus opposite said mixture.

11. The method of claim 7, wherein said bonding step comprises:
heating said sheet to a temperature sufficient to melt at least a portion of said thermoplastic bonding material, wherein said thermoplastic bonding material becomes adhesive and bonds at least a portion of said bundles of dried reinforcing fibers and said thermoplastic bonding material.

12. The method of claim 7, further comprising the steps of:
compacting said chopped strand mat; and
cooling said compacted chopped strand mat.

13. The method of claim 12, further comprising the step of:
winding said cooled, compacted chopped strand mat onto a continuous roll.

14. A method of forming a composite mat comprising the steps of:
dielectrically drying bundles of wet reinforcement fibers to form dried bundles of reinforcement fibers;
depositing said dielectrically dried bundles of reinforcement fibers onto a polymer mat, said polymer mat being formed of a polymeric bonding material, said polymeric bonding material having a melting point lower than the melting point of said dielectrically dried bundles of reinforcement fibers; and
bonding said dried bundles of reinforcement fibers and said polymeric bonding material to form a composite mat.

15. The method of claim 14, further comprising the step of:
conveying said dried bundles of reinforcement fibers to a forming hood where said dried bundles of reinforcement fibers are dispersed in an air stream after said drying step.

16. The method of claim 15, further comprising the step of:
positioning said polymer mat on a conveying apparatus within said forming hood prior to said depositing step.

17. The method of claim 15, wherein said step of dielectrically drying said bundles of wet reinforcement fibers comprises:
introducing said bundles of wet reinforcement fibers into a dielectric oven wherein said bundles of wet reinforcement fibers are passed through high alternating frequency electrical fields and dried.

18. The method of claim 14, wherein said bonding step comprises:
heating said dried bundles of reinforcement fibers and said polymer mat to a temperature sufficient to melt at least a portion of said polymeric bonding material, said polymeric bonding material becoming adhesive and bonding at least a portion of said bundles of dried reinforcing fibers and said polymeric bonding material.

19. The method of claim 16, wherein said dried bundles of reinforcement fibers are deposited onto said polymer mat by a vacuum positioned on a side of said conveying apparatus opposite said polymer mat.

20. The method of claim 14, further comprising the steps of:
compacting said composite mat;
cooling said composite mat; and
winding said cooled, compacted composite mat onto a continuous roll.
